(19) United States
(12) Patent Application Publication
(10) Pub. No.: US 2025/0349213 A1
(43) Pub. Date: Nov. 13, 2025

(54) SYSTEM FOR PHASE OF FLIGHT RECOGNITION VIA MACHINE LEARNING

(71) Applicant: BETA AIR, LLC, South Burlington, VT (US)

(72) Inventors: Ali Ossama Soliman Tarabay, Montreal (CA); Paulina Ramsey Mangan, Burlington, VT (US)

(21) Appl. No.: 18/657,236

(22) Filed: May 7, 2024

(51) Int. Cl. G08G 5/00

(52) U.S. Cl. CPC G08G 5/21; G08G 5/32

(57) ABSTRACT

Disclosed implementations for categorizing flight data from a mission or a series of missions according to phases of flight of an aircraft. Flight data that is divided according to a plurality of time intervals and associated with a mission flown by an aircraft is received. Categorized flight data is determined by categorizing each of the plurality of time intervals of the flight data into at least one of a plurality of phases of flight. The categorized flight data is provided to a user interface for post flight analysis of the mission.

### BACKGROUND

The stages or phases of flight of an aircraft (also referred to as regimes) refer to the different phases that an aircraft goes through during its flight. These stages may include taxiing, takeoff, climb, cruise, descent, approach, and landing.

### SUMMARY

Implementations of the present disclosure are generally directed to categorizing flight data from a flight mission or a series of flight missions according to phases of flight of an aircraft. In some implementations, the flight data is processed through a model trained to categorize the flight data at each of a series of time intervals or timestamps (e.g., every t number of seconds). In some implementations, the model is trained to differentiate between a number of unique phases of flights using the telemetry signals and other sensor data included in the flight data. In some implementations, the model is trained to identify both conventional takeoff or landing (CTOL) phases and vertical takeoff or landing (VTOL) phases as well as unique mission profiles. Once categorized according to the model, the flight data can be used for post-flight analysis, monitoring of diagnostics and trends (e.g., of the aircraft or pilot), and time tracking. In some examples, the categorized flight data is queryable and may be employed to generate metrics and pages provided via a telemetry exploration tooling.

Methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 depicts an example architecture of the described phase-of-flight system that can be employed to conduct post flight analysis;

FIG. 2 depicts an example decision tree representation that may be employed with the architecture of FIG. 1 to categorize an interval of flight data into a phase of flight;

FIG. 3 is a chart depicting example flight data categorized according to implementations of the described system;

FIG. 4 depicts an example of an aircraft that can be employed to record flight data;

FIG. 5 depicts an example environment that can be employed to execute implementations of the present disclosure;

FIGS. 6A-6D are example user interfaces that can be employed for post flight analysis;

FIG. 7 is a flowchart of a non-limiting process that can be performed by implementations of the present disclosure; and

FIG. 8 depicts an example system that includes a computer or computing device that can be programmed or otherwise configured to implement systems or methods of the present disclosure.

### DETAILED DESCRIPTION

General aviation operations have benefited from the wide availability of flight data provided by the instrumentation on board aircraft. Accordingly, identifying the phases of flight in which the aircraft was operating during a particular flight and over the lifetime of the aircraft is useful for most a posteriori data-driven analyses. However, the magnitude and diversity of flight data, which may include data collected during a flight, makes identification of phases of flight a time-consuming and complicated task. For example, flight data may be recorded from a primary onboard computer and data logging computers on an aircraft. These systems provide data from differing sources covering a wide range of sensors, from strain gauge data to high-frequency vibration sensors. Moreover, the sensor data is recorded when the aircraft is powered on, regardless of whether the aircraft is engaged in an actual flight.

In one example use case, a user (e.g., flight test engineers or FTEs, users responsible for predicting required maintenance of components, and the like) may require identification of phases of flight for postflight analysis, life-cycle analysis, and the like. Solutions for identifying such phases of flight are currently slow and error prone. For example, hundreds of flight test logs prepared after each flight must be parsed to find meaningful data (e.g., flights of interest) and to identify the phases of flight for the identified flight(s). Moreover, information that is not directly available from the on-board computing system from which telemetry data is obtained, such as aircraft configuration information, must be retrieved (e.g., from separate databases and file repositories). Often, the process is repeated if the data is invalid, or if the analysis requires multiple demonstrations of, for example, a specific maneuver that includes multiple phases of flight in a particular order. Furthermore, variation in operating conditions, pilot inputs, and aircraft condition may result in variance in the aircraft response. This variability can be assessed if access to large scale data is available. If the process of finding this data is sufficiently prohibitive, the user may limit their analysis to one or two maneuvers that are ‘good-enough’, which may not accurately represent the underlying aircraft behavior, thus introducing inaccuracies and errors to current processes.

However, this abundance of this flight data can be processed via statistical methods and models that rely on, for example, large datasets for prediction and categorization to maximize value extraction. Accordingly, the described system processes flight data through a statistical model to identify the phases of flight for an aircraft during a particular flight as well as a number of flights during a particular time frame up to and including the lifetime of the aircraft. In some implementations, the flight data is processed through the statistical model (e.g., via the onboard computer) as the data is received from the various sensors, an outcome impossible using manual methods. In some implementations, the flight data is provided to a back-end system after a flight(s) and the back-end system is configured to process the flight data through the statistical model.

In some cases, flight data (e.g., telemetry data as well as data provided by strain gauges or accelerometers) collected by an aircraft (e.g., via the onboard computer providing an aircraft monitoring system or flight management system) from a particular flight(s) or over a period of time includes features such as airspeed, ground speed, altitude, heading, propulsion throttle input, pusher throttle input, hover throttle input, weight on wheels indicator, charging signal indicator, or the like. As used herein, pusher throttle input and hover throttle input include a signal indicating an amount of throttle applied by the pilot controlling pusher and lift motors respectively (similar to an accelerator on an automobile). As used herein, weight on wheels includes a signal that indicates whether the aircraft's landing gear is supporting the aircraft's weight. As used herein, a charging signal includes a signal indicating that an on-board battery pack(s) is ready to accept current for charging.

As an example, the statistical model may be configured to use the heading signal when differentiating between the various on-ground phases (e.g., taxiing) because before a takeoff or after a landing, a pilot often transitions from the taxiway onto the runway or vice versa, which is usually associated with a large change in heading and can signal the beginning or end of the taxiing phase.

In some cases, the phases of flight that the statistical model is configured (e.g., trained) to identify include, by are not limited to, one or more of standing, taxi, takeoff, climb, cruise, descent, landing, hover, transition-in, transition-out, charging, and the like. In some implementations, the statistical model is configured to ensure high recall for critical, short phases of flight such as hover, takeoff, landing, or transitions.

Some phases of flight (e.g., takeoff and landing) may be limited to CTOL mission profiles while other phases of flight (e.g., hover and transition) may be limited to VTOL mission profiles. Accordingly, the flight data may be categorized based on the phases of flight associated with the type of missions flown (e.g., VTOL or CTOL). In some cases, the particular phases of flight are associated with a mission profile rather than the type of aircraft as some aircraft are capable of executing multiple mission profiles (e.g., a VTOL aircraft may be capable of performing CTOL takeoff and landing as well as a VTOL mission profile).

In some cases, the standing phase includes when an aircraft is ON but not moving. In some cases, the taxi phase includes when an aircraft is moving on the ground using the propulsion system of the aircraft. In some cases, the takeoff phase starts at throttle engagement until a set altitude (e.g., about fifty feet) above the ground. In some cases, the climb phase includes when the altitude of an aircraft is increasing above a set rate (e.g., about 50 feet per minute). In some cases, the cruise phase includes when an aircraft is moving in air with minimum change in altitude (<50 ft per minute). In some cases, the descent phase includes when the altitude of an aircraft is decreasing above a set rate (e.g., above 50 feet per minute). In some cases, the landing phase starts at a set distance (e.g., about fifty feet) above ground and ends when the aircraft exits the runway. In some cases, the charging phase includes when onboard batteries are receiving current from an external source. In some cases, the charging phase depends on the charging signal indicator derived from aircraft telemetry data.

In some cases, the hover phase depends on the hover throttle input and the weight-on-wheels signal. For example, a hover throttle input may include an input command to lift propulsion units for generating vertical thrust. The input command could be any command known in the art, including revolutions per minute (RPM), torque, or thrust. In some examples, the hover throttle input may include a value between 0% and 100%. In some cases, the hover phase begins when the weight of the aircraft is no longer supported by the landing gear wheels (a weight on wheels signal of approximately zero, also referred to herein as no weight on wheel signal) where lift is achieved using solely the aircraft lift motors and ends at the application of power to the pusher propeller (e.g., when pusher throttle exceeds a threshold value). In some cases, a full weight on wheels state is defined when the weight on wheels signal value is two, a partial weight on wheels state when the weight on wheel signal value is one, and a no weight on wheel state when the signal value is zero. In other examples, in addition to or instead of a weight on wheels signal, one or more other sensor types that directly or indirectly indicate a height of the aircraft above the ground (e.g., an altimeter, radar, lidar, or the like) may be used to determine when the aircraft was in the hover phase of flight.

In some cases, for a lift-plus-cruise configuration aircraft, the transition phase depends on a pusher throttle signal in addition to the signals used to categorize the hover phase. For example, a pusher throttle input or signal may include an input command to one or more propulsion units for generating horizontal thrust. The input command could be any command known in the art, including RPM, torque, or thrust. In some examples, the pusher throttle input may include value between 0% and 100%. In tilt rotor aircraft, for example, the transition phase may depend on a tilt signal that indicates one or more propulsion units are transitioning from a vertical operation orientation to a horizontal operation orientation. In some cases, the transition phase includes two sub-phases: transition-out and transition-in. The transition-out sub-phase, in the case of lift-plus-cruise flight mode, begins with the application of power to a pusher propeller, and ends when no power is provided to lift propellers and lift is provided solely by the aircraft wings. The transition-in sub-phase, begins with the application of power to the lift propeller, and ends when the aircraft ground speed is approximately zero (at this point, lift is primarily provided using the aircraft lift motors).

### Example Architecture

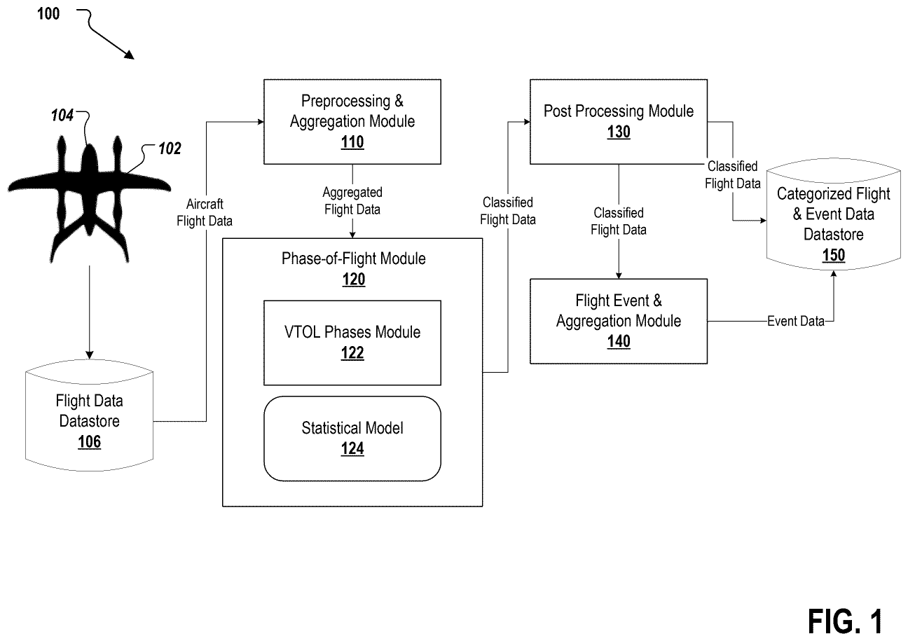

FIG. 1 is an example architecture 100 of the described phase-of-flight system that can be employed to conduct post flight analysis. As depicted, the example architecture 100 includes aircraft 102, onboard computing device(s) 104, flight data datastore 106, preprocessing and aggregation module 110, phase-of-flight module 120, post-processing module 130, flight event and aggregation module 140, and categorized flight and event data datastore 150. As depicted, the phase-of-flight module 120 includes VTOL phases module 122 and the statistical model 124.

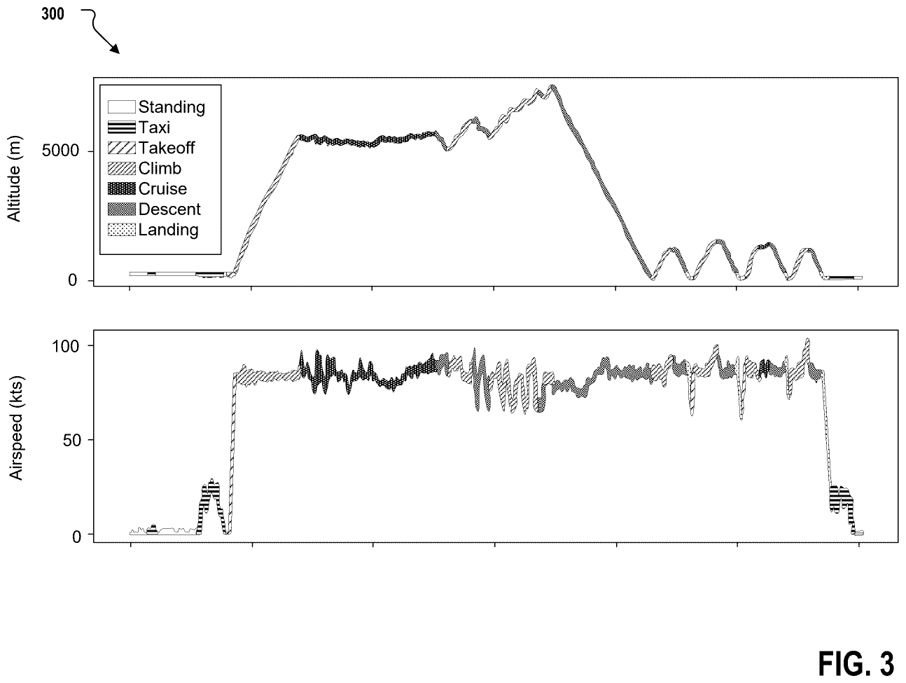

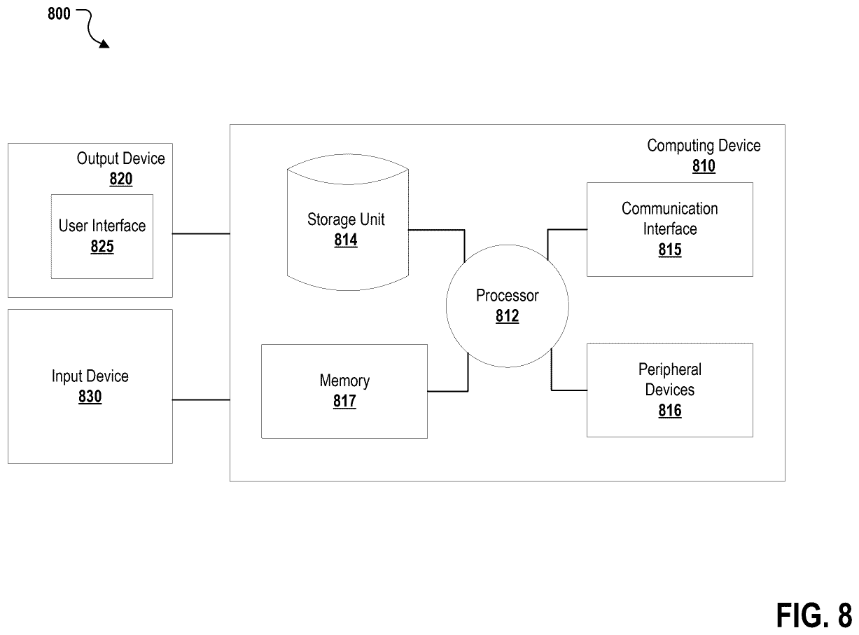

In some cases, the aircraft 102 is an electric aircraft and includes the onboard computing device 104. In some cases, the aircraft 102 is a CTOL or VTOL aircraft. Generally, the onboard computing device(s) 104 is configured (e.g., the electronic processors programmed) to receive and record the flight data from the various sensors onboard the aircraft 102 (see FIG. 3 for a more detailed description of the aircraft 102 and the onboard sensors). In some implementations, the onboard computing device 104 is substantially similar to the computing device 810 described below with reference to FIG. 8.

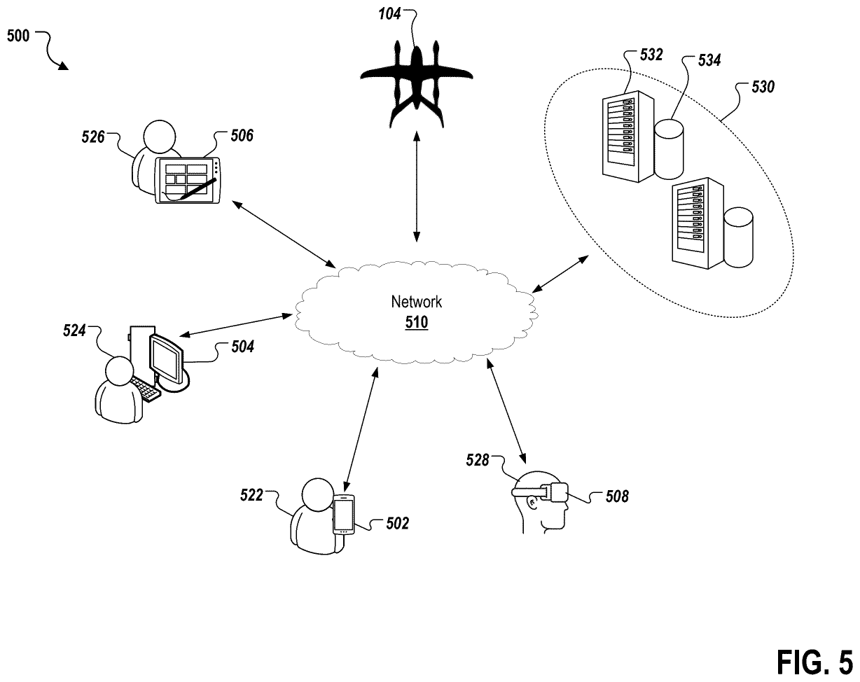

The recorded flight data is transferred from the onboard computing device 104 to the flight data datastore 106. In some implementations, the onboard computing device 104 is configured to provide the flight data to the flight data datastore 106 via a network (e.g., the communications network 510 of FIG. 5). In some implementations, a user downloads the recorded flight data directly from the onboard computing device 104 and uploads the flight data to the flight data datastore 106 or via an application executed on, for example, a handheld computing device (e.g., a tablet).

In some implementations, the onboard computing device 104 is configured to execute some or all of the components and modules of the example architecture 100. For example, in some implementations, the flight data datastore 106 and event data datastore 150 are stored on the memory of the onboard computing device 104 and the onboard computer is configured to process the flight data via the preprocessing and aggregation module 110, the phase-of-flight module 120, the post-processing module 130, and flight event and aggregation module 140 and store the categorized flight data and determined event data to the categorized flight and event data datastore 150. In some implementations, the onboard computing device 104 is configured to provide the data from the categorized flight and event data datastore 150 to a backend-end system (e.g., the back-end system 530 described below with reference to FIG. 5), which provides, for example, cloud storage of the data. In some implementations, some or all of the components and modules of the example architecture 100 are executed by the backend-end system.

In some implementations, the categorized flight and event data datastore 150 is a data lake. Generally, a data lake is a data storage location where a large amount of heterogeneous data from different sources (e.g., flight data from various aircraft) is stored in a raw state. In some implementations, a data lake is schema-less but is partitioned to aid in search-ability and to reduce query time. In some implementations, to improve query times, a subset of data stored within a data lake is transformed to structured SQL and stored in a more traditional database. In some implementations, metadata associated with aircraft flight data is stored with the flight data. Metadata may include type of mission; weather data during the flight including wind speed, wind direction, and other atmospheric conditions; weight of the aircraft; weight of cargo; center of gravity; flight test reports; operating pilot information; FTE notes or the like).

Generally, the preprocessing and aggregation module 110 receives (e.g., via a query) the flight data stored to the flight data datastore 106 and verifies that the signals required for classification are available. In some examples, the flight data includes information related to a single flight of the aircraft 102. In some examples, the flight data includes information related to multiple flights of the aircraft 102 over a period of time. In some examples, the flight data includes information related to multiple flights of the aircraft 102 as well as other aircraft over a period of time.

In some implementations, the preprocessing and aggregation module 110 identifies the start time and end time of each flight represented in the flight data (e.g., using the phase categorizations from the statistical model 124). In some implementations, these times are identified as the first timestamp of the first takeoff of a flight (as categorized by the model) until the last timestamp of the last landing respectively. In some implementations, the preprocessing and aggregation module 110 then associates metadata related to the identified flight (e.g., aircraft configuration, meteorological conditions, or the like) based on the start and end times as well as information related to the aircraft or pilot (e.g., a unique identifier for the aircraft or pilot).

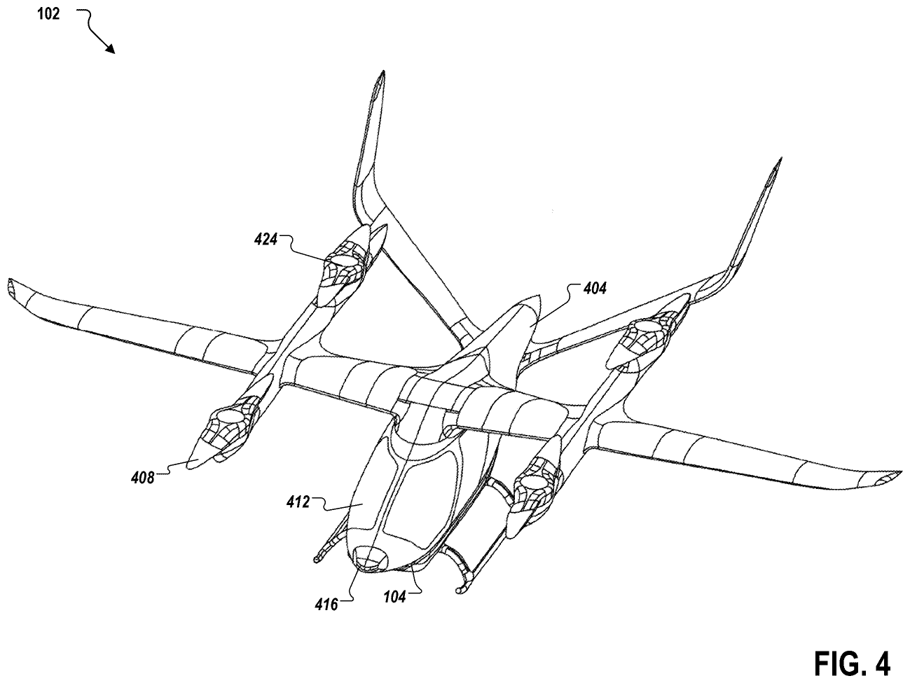

The preprocessing and aggregation module 110 provides the aggregated flight data to the phase-of-flight module 120. Generally, the phase-of-flight module 120 determines a start time and end time for each flight represented in the aggregated flight data and divides the flight data during each flight into a number of intervals (e.g., every tenth of a second, quarter of a second, half of a second, second, 2 seconds, 3 seconds, 4 seconds, 5 seconds, 6 seconds, 7 seconds, 8 seconds, 9 seconds, 10 seconds, and so forth). In some cases, the length of intervals is set according to an interval value that is determined based on, for example, the aircraft or information related to the specific flight or series of flights flown by the aircraft(s). Each interval during a flight is assigned a phase based on the information from the aggregated flight data as well as other associated metadata. In some implementations, the phase at each interval is included as categorized data with the aggregated flight data. This categorized flight data is provided to the post-processing module 130. The phase-of-flight module 120 is described in more detail below with reference to FIG. 4.

The post-processing module 130 processes the categorized flight data to remove fluctuations and anomalies in the data based on a rule set or a rule matrix. For example, a rule set may define an anomaly as a phase covering less than a threshold number of intervals (e.g., less than one to five seconds). In such examples, the categorization of the intervals within the anomaly may be removed or corrected (e.g., assigned a different phase determined based on the previous and subsequent categorization of intervals of the flight data).

In some cases, certain phases (e.g., takeoff and landing) are prioritized over other phases when determining a phase of an interval or over a certain window of intervals. For example, the prioritization may be implemented by assigning a threshold value for a predicted probability of a takeoff or landing phase above which the model will select takeoff or landing even if the model predicts one of the other phases with a higher level of probability.

Moreover, the post-processing module 130 may be used in conjunction with the prioritization of takeoff and landing to eliminate false positive predictions. For example, an anomaly may represent unreasonable phase transitions (e.g., a cruise followed by a takeoff, a takeoff or landing in the middle of a series of cruise phases, and so forth), and may be corrected, ignored, or otherwise removed.

In some implementations, a matrix of legal/reasonable/allowable phase transitions (e.g., for the particular type of mission) is employed such that phase transitions that violate the transitions allowed in the matrix are removed as anomalies.

Flight event and aggregation module 140 aggregates and analyzes the flight data provided by the post-processing module 130 to determine events for one particular mission or multiple missions that are related to the aircraft, mission, pilot, and the like. For example, data related to a particular component of an aircraft (e.g., a number of times the component is subject to a particular event) can be determined based on the categorized flight data associated with the flight mission. In some cases, the event data may be used to predict performance, determine a maintenance schedule, determine an evaluation metric for a pilot or aircraft, and so forth. In some cases, the event data may be combined with related metadata for postflight analysis.

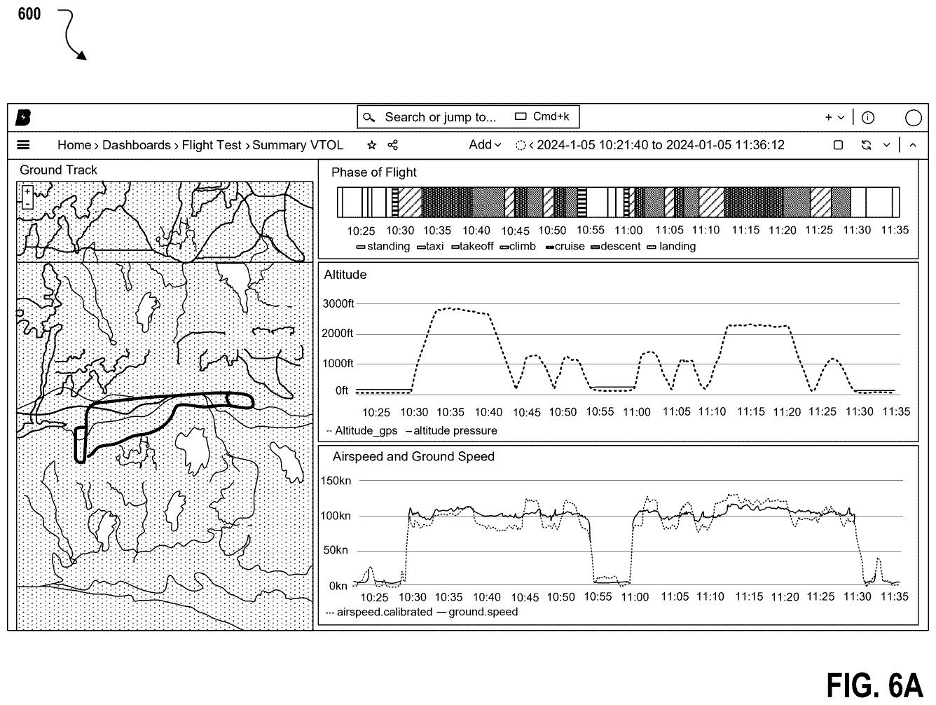

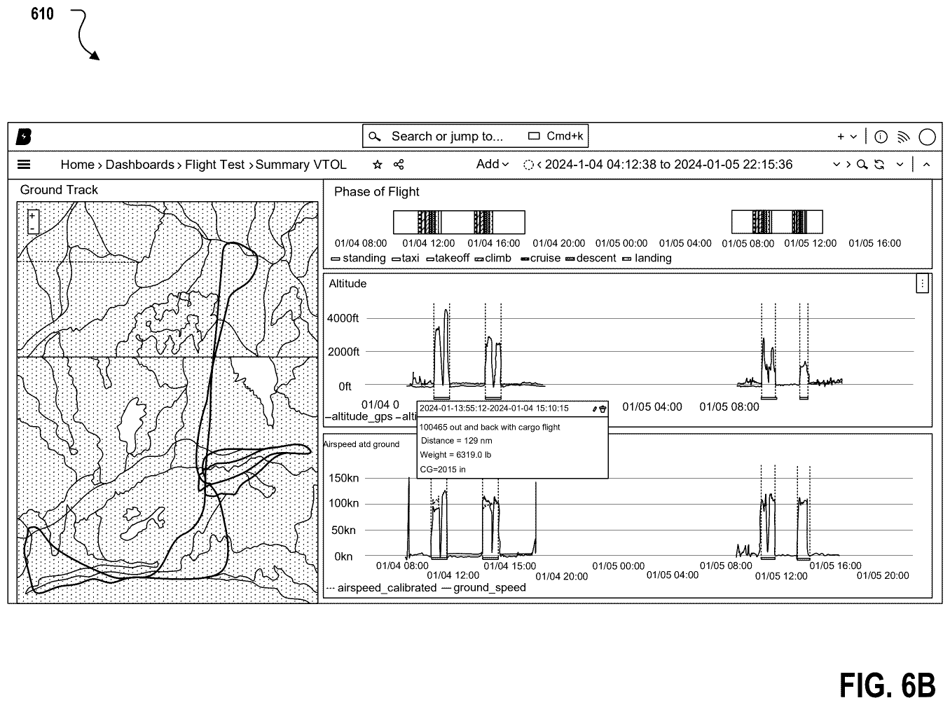

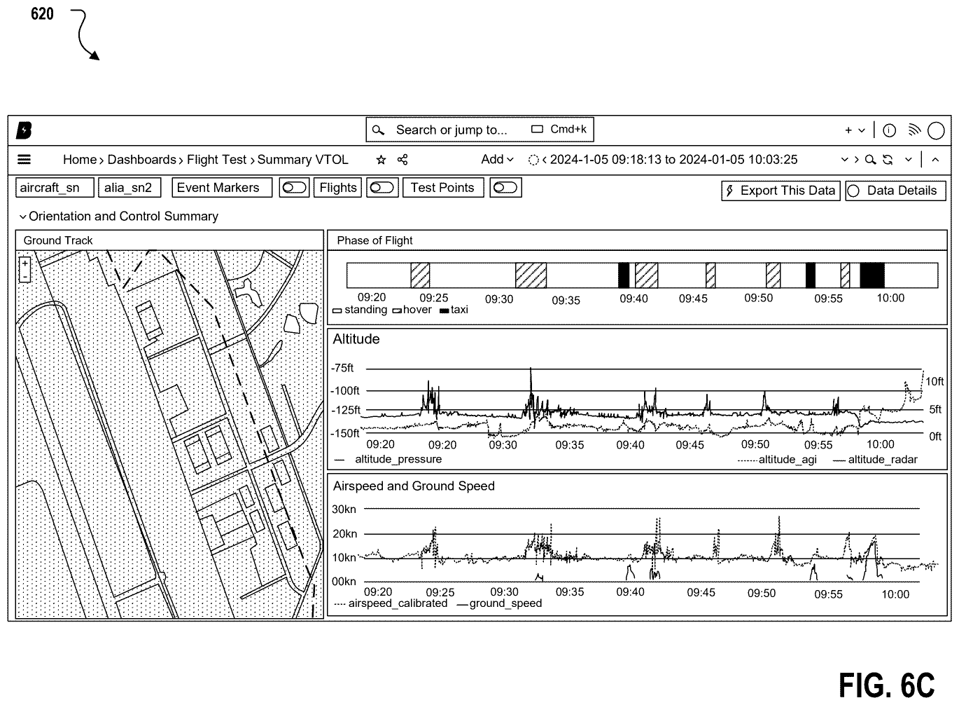

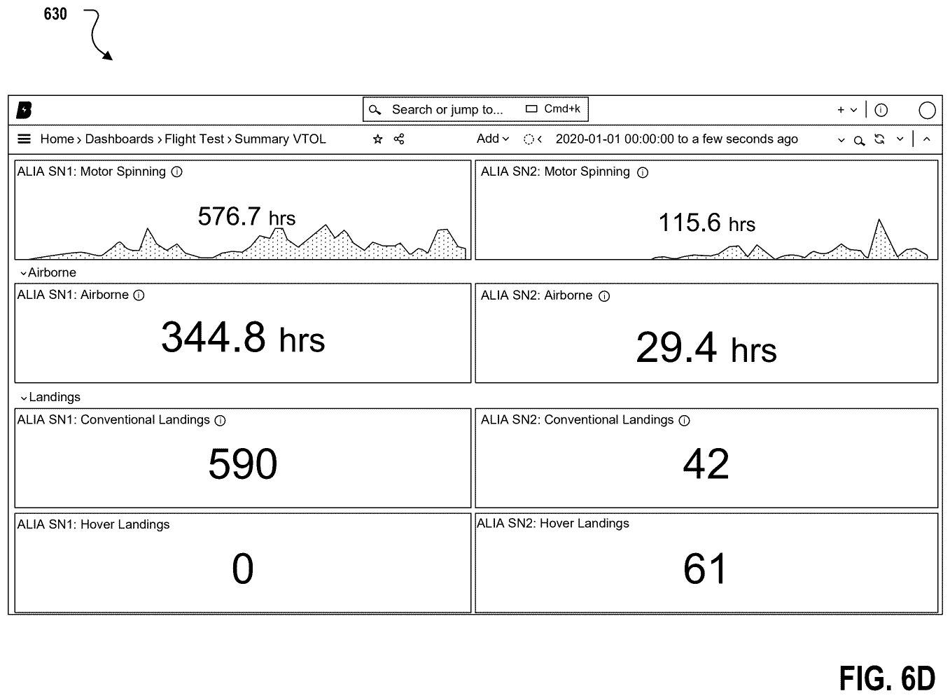

The post-processing module 130 and the flight event and aggregation module 140 store the categorized flight data and flight event data, respectively, to the categorized flight and event data datastore 150. In some cases, information stored to the categorized flight and event data datastore 150 can be mined or queried via a user inference for postflight analysis (see the description of FIGS. 6A-6D below). As used herein, data mining includes a process for mapping low-level data into other forms that might be more compact (e.g., a short report), more abstract (e.g., a descriptive approximation or model of the process that generated the data), or more useful (e.g., a predictive model for estimating the value of future cases).

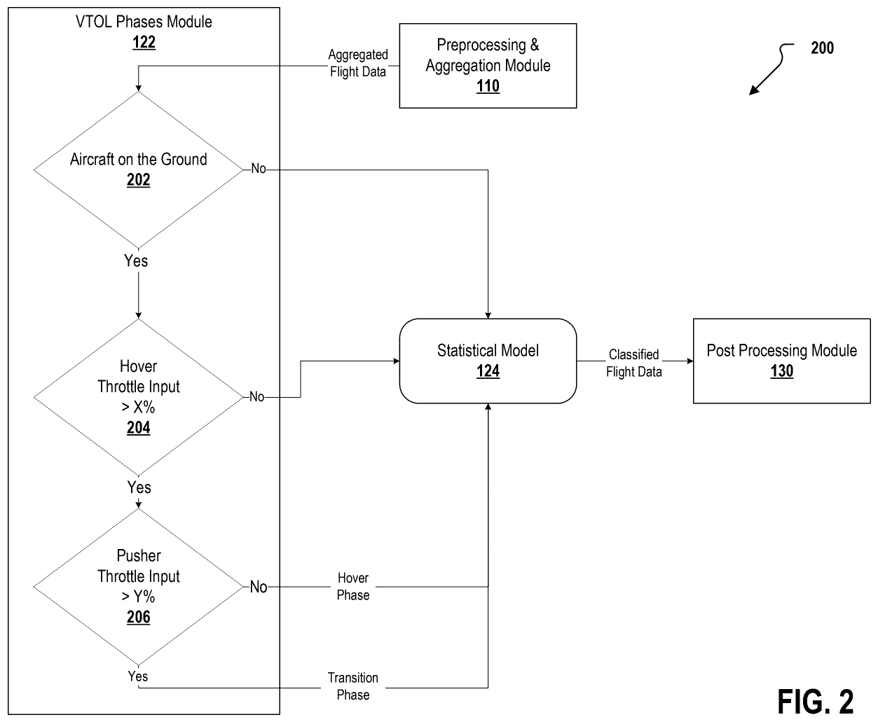

FIG. 2 is an example process 200 that may be employed with the architecture 100 to categorize an interval of flight data into a phase of flight. As shown in FIG. 2, in some examples, methods of the present disclosure combine a rule-based classification logic component (e.g., provided via VTOL phases module 122) for identifying VTOL phases of flight with statistical model 124 (e.g., a gradient boosting model) for identifying other phases of flight. The process 200 may be employed within the phase-of-flight module 120.

As depicted, the decisions 202, 204, and 206 are employed by the VTOL phases module 122 to categorize each interval (e.g., one second) of flight data with phases of flight specific to VTOL flight (e.g., hover, transition) and to otherwise provide the flight data to the statistical model 124, which is configured to categorize phases of flight other than hover and transition.

Various operations of the process 200 can be run in parallel, in combination, in loops, or in any order. For example, FIG. 2 depicts the VTOL phases module 122 as processing the aggregated flight data before providing the data to the statistical model 124. It is contemplated, however, that implementations of process 200 include the statistical model 124 processing the aggregated flight data before providing the data to the VTOL phases module 122 or an implementation where the VTOL phases module 122 and statistical model 124 are configured to process the flight data in parallel.

At decision 202, the aggregated flight data provided by the preprocessing and aggregation module 110 is processed to determine whether the aircraft is on the ground at each interval. For example, at each interval, when airborne signals indicate that the aircraft is airborne (e.g., when no weight on wheel signal is observed or based on an altitude above ground indicator, such as radar altitude), the aggregated flight data associated with the respective interval is not categorized with a VTOL specific phase. When airborne signals indicate that the aircraft is on the ground (e.g., the weight on wheel signal is determined), the aggregated flight data associated with the respective interval is provided to decision 204.

At decision 204, the flight data for an interval is processed to determine the hover throttle input. When the hover throttle input is over a hover throttle threshold value (e.g., 50%), the flight data associated with an interval is provided to decision 206. When the hover throttle input is below the hover throttle threshold value, the aggregated flight data associated with the respective interval is not categorized with a VTOL specific phase.

At decision 206, the flight data for an interval is processed to determine the pusher throttle input or the hover throttle input. When the pusher throttle input is over a pusher throttle threshold value (e.g., 10%), the flight data associated with an interval is categorized as transition phase. When the pusher throttle input is below the pusher throttle threshold value, the flight data associated with an interval is categorized as hover phase. In other implementations, when the hover throttle input indicates that the lift propulsors start tiling forward, the flight data associated with an interval is categorized as a transition phase, even if the pusher throttle is over the threshold value.

As depicted, once the VTOL phases module 122 has categorized the intervals in the flight data with the VTOL specific phases, the aggregated flight data is provided to the phase-of-flight module 120. In some implementations, the categorization of the VTOL phase is integrated into the statistical model 124. In some implementations, as indicated above, the phase-of-flight module 120 processes the aggregated flight data before the VTOL phases module 122 has categorized the intervals in the flight data with the VTOL specific phases.

In some implementations, the statistical model 124 is configured to ingest each individual data point of the aggregated flight data sequentially. In such implementations, each data point represents one interval unit (e.g., one second) of flight data and the model is configured to categorize each data point into the appropriate phase of flight. Such an approach may be used when the statistical model 124 is built using a model having memory-like attributes, such as various models based on neural networks, that can independently learn the relationship between sequential instances.

In some implementations, the statistical model 124 is configured to identify a phase of flight for the respective flight at a defined interval. In some implementations, the statistical model 124 is configured to categorize the flight data with the identified phase of flight at each configured interval (e.g., provided as metadata). In some implementations, the statistical model 124 is configured to employ a rolling window (or sub-segments) over multiple intervals when categorizing a particular interval into a phase of flight. For example, after an initial pass through the flight data, the statistical model 124 may use a rolling window that includes a number of past and future phases when identifying a phase of flight at a particular interval.

A rolling window may be employed to improve the ability to capture temporal features of the flight data, particularly for models that do not have memory-like attributes, such as classical machine learning models which may be based on decision trees rather than neural networks. Because of this reason classical machine learning models are typically not well suited for classifying temporal data, such as flight test data. However, they typically require less training data and processing time and resources. In the context of predicting phases of flight, particularly for flight test data, which can be more sparse and costly to obtain, the lower volume of required training data can be beneficial. To overcome the deficiency of classical models for processing temporal data, various feature engineering techniques may be employed.

In some examples, temporal signals are aggregated by calculating a plurality of metrics associated with the data within each grouping of data, such as statistical metrics (average, maximum value, minimum value, or the like). The number of features for the model can be further extended by calculating a plurality of metrics over varying window sizes. Such an approach may be used when the statistical model 124 is built using a model having no contextual or memory-like attributes, such as classical machine learning models but may be also utilized for neural networks and deep neural network models. In some implementations, the statistical model 124 is configured to process a statistical summary of each window (minimum altitude, average speed, or the like) when categorizing a particular interval.

As an example, when the interval is every second of flight data, the window size may be set to several seconds (e.g., 5 to 120 seconds) before or after the particular data point. In some implementations, the window length for the statistical model 124 ranges from about 10 seconds to about 90 seconds. In other implementations, the window length for the statistical model 124 ranges from about 10 seconds to about 5 minutes. In some implementations, a target label of each window is set to the phase of flight at the window midpoint. In some examples, a set of time windows may be developed during hyperparameter tuning and optimization.

Depending on the particular feature included in the flight data (e.g., altitude), different types of summary statistics can be used to capture the temporal information captured within each window. For example, in some implementations, an average value may be used for airspeed and altitude for each window while a total change is used for heading (e.g., the sum of delta heading each second) and a maximum value is used for throttle (e.g., pusher throttle feature, may be used as the types of summary statistics). In some implementations, a change in speed or altitude over the window length is also added to the input for the statistical model 124. In some implementations, the statistical model 124 inputs are augmented by extracting these summary statistics over a plurality of windows of different lengths, which are used as model inputs. For example, statistics for two, three, four, five, or more different time windows of different lengths can be determined and fed as different features into the statistical model 124. In some implementations, the statistical model 124 is trained using pre-labelled flight data, synthetic data provided via simulation models, or a combination thereof. In some examples, the temporal data used by the statistical model 124 includes one or more of altitude, airspeed, heading, and propulsion throttle input. In some examples, statistical metrics for groupings or time windows of the data may include one or more of average, total change, maximum value, rate of change, median, among others. As noted above, for each of the signal types, one or more of the foregoing summary metrics may be calculated over a plurality of time durations or time windows. In yet other examples, additional features may be generated by combining the metrics from multiple time windows, such as by concatenating one or more metrics from different length time windows.

In some implementations, the statistical model 124 is trained via supervised or semi-supervised learning. In some implementations, clustering techniques are employed to classify phases with the statistical model 124. Any of a variety of types of supervised learning models may be used. For example, a first category of models that may be used include classic models that are applicable to both temporal and non-temporal data. In some cases, as described above, feature engineering is employed to capture the temporal properties of the data to aid categorization. Examples of classical machine learning models also referred to herein as classical statistical models, include Support Vector Machines (SVM), Random Forests, and Gradient Boosting models. Another example category of models that may be used include neural network-based models which may have properties suitable for time-series data analysis with memory-like attributes allowing capture of temporal dependencies and learning of the context of each data point and the effect on the phase categorization. Examples from this second category include, but are not limited to, Long Short-Term Memory (LSTM) and Bi-directional LSTM models. Another example category of models include models that do not have memory-like attributes, however less feature engineering (as compared to the first category) may be required as these models can learn the unique features associated with time series data. Generally, this third category of models are able to identify and learn unique attributes of time series sub-segments without manual feature engineering. These unique attributes can be used to categorize unseen data. Examples for this third category include, but are not limited to, the Shapelet Transform Classifier and the Hierarchical Vote Collective of Transformation-based Ensembles (HIVE-COTE) model. In some implementations, the statistical model 124 is a supervised, histogram-based gradient boosting model.

In some implementations, once each of the intervals in the flight data are categorized according to the phases of flight, the categorized flight data is provided to the post-processing module 130 described above with reference to FIG. 1.

### Example Categorized Flight Data

FIG. 3 is a chart 300 depicting example flight data categorized according to implementation of the described system. The chart 300 includes example altitude and airspeed data from a particular flight of an aircraft, such as aircraft 102. Although altitude and airspeed data are shown in FIG. 3, other flight data, such as described herein, may be depicted in a similar manner once categorized according to implementation of the described system.

As shown in FIG. 3, both the takeoff and landing phases of flight are well captured. Also shown in the depicted data is the describe system's ability to distinguish between a go-around (an aborted landing where the aircraft never touches the runway) and a touch-and-go (a landing immediately followed by a takeoff).

### Example Aircraft

FIG. 4 shows an example of the aircraft 102. In some implementations, the aircraft 102 is an electrically powered aircraft (electric aircraft). In other implementations, the aircraft 102 is a fuel powered aircraft (e.g., jet fuel, gasoline, hydrogen, or the like). In some implementations, the aircraft 102 is an electric VTOL (eVTOL) aircraft or an electric CTOL (eCTOL) aircraft. In some implementations electric aircraft are capable of rotor-based cruising flight, rotor-based takeoff, rotor-based landing, fixed-wing cruising flight, airplane-style takeoff, airplane-style landing, and/or any combination thereof. The term rotor-based flight includes where an aircraft generates lift and propulsion by way of one or more powered rotors coupled with an electric motor, such as a quadcopter, multi-rotor helicopter, lift-plus-cruise, or other vehicle that maintains its lift primarily using downward thrusting propulsors. The term fixed-wing flight includes where an aircraft is capable of flight using wings and/or foils that generate lift caused by the aircraft's forward airspeed and the shape of the wings and/or foils, such as airplane-style flight.

As depicted in FIG. 4, the aircraft 102 includes a fuselage 404. The fuselage 404 includes structural elements that physically support the shape and structure of the aircraft 102. As depicted in FIG. 4, the aircraft 102 includes a plurality of actuators 408 configured to produce a torque. In some implementations, the actuators 408 include a rudder or a segmented rudder that produces a torque about a vertical axis. In some implementations, the actuators 408 include rotors, turbines, ducted fans, paddle wheels, or other components configured to propel a vehicle through a fluid medium including, but not limited to air. In some implementations, the actuators 408 include at least one propulsor component. Generally, a propulsor component or propulsor is a component or device used to propel a craft by exerting force on a fluid medium, which may include a gaseous medium such as air or a liquid medium such as water. In some implementations, a propulsor component includes a puller component. Generally, a puller component includes a component that pulls or tows an aircraft through a medium. In some implementations, a propulsor component includes a pusher component. Generally, a pusher component includes a component that pushes or thrusts an aircraft through a medium. In some implementations, a propulsor component includes a propeller, a blade, or any combination of the two. In some implementations, a propeller functions to convert rotary motion from an engine or other power source into a swirling slipstream which may push the propeller forwards or backwards.

In some implementations, an actuator of the plurality of actuators 408 is mechanically coupled to the aircraft 102. In some implementations, the actuators 408 include power sources, control links to one or more elements, fuses, or mechanical couplings used to drive or control any other flight component. In some implementations, the actuators 408 include a motor 424 that operates to move one or more flight control components or one or more control surfaces, to drive one or more propulsors, or the like. In some implementations, the motor 424 includes electronic speed controllers, inverters, or other components for regulating motor speed, rotation direction, and/or dynamic braking.

In some implementations, the actuators 408 include an energy source. An energy source may include, for example, a generator, a photovoltaic device, a fuel cell such as a hydrogen fuel cell, direct methanol fuel cell, and/or solid oxide fuel cell, an electric energy storage device (e.g. a capacitor, an inductor, or a battery). An energy source may also include a battery cell, or a plurality of battery cells connected in series into a module and each module connected in series or in parallel with other modules.

As depicted in FIG. 4, the aircraft 102 includes a pilot control 412. A pilot control may include without limitation, a hover control, a thrust control, an inceptor stick, a cyclic, and/or a collective control. As depicted in FIG. 4, the aircraft includes a sensor 416. In some implementations, the sensor 416 includes a sensor or noise monitoring circuit and is configured to sense a characteristic of the pilot control 412. In some implementations, the sensor 416 include a device, module, or subsystem, employing hardware, software, or any combination thereof to sense a characteristic or changes thereof, in an instant environment with which the sensor is proximal to or otherwise in a sensed communication with, and transmit information associated with the characteristic as, for example, flight data.

In some implementations, the sensor 416 is mechanically or communicatively coupled to the aircraft 102. In some implementations, the sensor 416 is configured to sense a characteristic associated with at least a pilot control 412. In some implementations, the sensor 416 includes an environmental sensor that may include without limitation one or more sensors used to detect ambient temperature, barometric pressure, or air velocity. In some implementations, the sensor 416 includes a motion sensor that may include without limitation gyroscopes, accelerometers, inertial measurement unit (IMU), or magnetic sensors. In some implementations, the sensor 416 includes a humidity sensor, an oxygen sensor, a geospatial sensor, a proximity sensor, a displacement sensor, a vibration sensor, or the like. The sensor 416 may be located inside the aircraft 102 or included in or attached to at least a portion of the aircraft 102. In some implementations, the sensor 416 the is used to monitor the status of the aircraft 102 and provide flight data (e.g., airspeed, ground speed, altitude, heading, pusher throttle input, hover throttle input, weight on wheels, charging signal indicator, or the like) to the onboard computing device 104 during flight.

### Example Environment

FIG. 5 depicts an example environment 500 that can be employed to execute implementations of the present disclosure. The example environment 500 includes computing devices 502, 504, 506, 508; the onboard computing device 104, a back-end system 530, and a communications network 510. The communications network 510 may include wireless and wired portions. In some cases, the communications network 510 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 510 may also include future developed networks. In some implementations, the communications network 510 includes the Internet, an intranet, an extranet, or an intranet and/or extranet that is in communication with the Internet. In some implementations, the communications network 510 includes a telecommunication or a data network.

In some implementations, the communications network 510 connects web sites, devices (e.g., the computing devices 502, 504, 506, and 508) and back-end systems (e.g., the back-end system 530). In some implementations, the communications network 510 can be accessed over a wired or a wireless communications link. For example, mobile computing devices (e.g., the computing device 502 can be a smartphone device and the computing device 506 can be a tablet), can use a cellular network to access the communications network 510.

In some implementations, the computing devices 502, 504, 506 and 508 are sustainably similar to the computing device 810 described below with reference to FIG. 8. The computing devices 502, 504, 506, and 508 may include (e.g., may each include) any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some examples, the users 522, 524, 526, and 528 interact with the system through a graphical user interface (GUI) (e.g., the user interface 825 described below with reference to FIG. 8) or client application that is installed and executing on their respective computing devices 502, 504, 506, or 508. In some examples, the computing devices 502, 504, 506, and 508 provide viewing data to screens with which the users 522, 524, 526, and 526, can interact. For example, the computing devices 502, 504, 506, and 508 may provide a user interface where a user may conduct post flight analysis (see the description of FIGS. 6A-6D below).

Four computing devices 502, 504, 506 and 508 that are associated with a user are depicted in FIG. 5 for simplicity. In the depicted example environment 500, the computing device 502 is depicted as a smartphone, the computing device 504 is depicted as a tablet-computing device, the computing device 506 is depicted as a desktop computing device, and the computing device 508 is depicted as an XR/AR/VR device. It is contemplated, however, that implementations of the present disclosure can be realized with any of the appropriate computing devices, such as those mentioned previously. Moreover, implementations of the present disclosure can employ any number of devices.

In some implementations, the back-end system 530 includes at least one server device 532 and optionally, at least one data store 534. In some implementations, the server device 532 is sustainably similar to computing device 810 depicted below with reference to FIG. 8. In some implementations, the server device 532 is a server-class hardware type device. In some implementations, the back-end system 530 includes computer systems using clustered computers and components to function as a single pool of seamless resources when accessed through the communications network 510. For example, such implementations may be used in data center, cloud computing, storage area network (SAN), and network attached storage (NAS) applications. In some implementations, the back-end system 530 is deployed using a virtual machine(s).

In some implementations, the data store 534 is a repository for persistently storing and managing collections of data (e.g. training data or image data that includes common elements, which can be employed to build or fill in missing elements of a model representing a real-world space). Example data stores that may be employed within the described system include data repositories, such as a database as well as simpler store types, such as files, emails, and so forth. In some implementations, the data store 534 includes a database. In some implementations, a database is a series of bytes or an organized collection of data that is managed by a database management system (DBMS). In some implementations, the data store 534 may be configured to provide flight data datastore 106 or the categorized flight and event data datastore 150 described above with reference to FIG. 1.

In some implementations, the back-end system 530 hosts one or more computer-implemented services provided by the described system with which users 522, 524, 526, and 526 can interact using the respective computing devices 502, 504, 506, and 508. For example, in some implementations, the back-end system 530 is configured to receive the flight data recorded by the onboard computing device 104 during a flight(s) via the network. In some cases, the onboard computing device 104 may be configured to provide the flight data (or categorized flight data) via the communications network 510 (e.g., when the aircraft 102 is back in a hangar). In other cases, a user may connect to the onboard computing device 104 directly (e.g., via another device or USB drive) and transfer the flight data to the back-end system via the communications network 510 (e.g., upload the flight data to a network capable device and then transfer the information to the back-end server via the communications network 510).

In some implementations, the back-end system 530 is configured to categorize the flight data according to implementation of the described system. In other implementations, the onboard computing device 104 is configured to categorize the flight data as the flight data is received or after a flight. In some implementations, the back-end system 530 is configured to provide the categorized flight data to the computing devices 502, 504, 506, or 508 for post flight analysis by the respective users 522, 524, 526, or 526 (e.g., via a user interface).

### Example User Interface

FIGS. 6A-6D each depict an example page 600, 610, 620, and 630 respectively of a user interface that can be employed for post flight analysis by a user (e.g., the users 522, 524, 526, and 528 using their respective computing devices 502, 504, 506, and 508). As described above, the example pages 600-630 show categorized flight data for a specific flight or multiple flights of a particular aircraft, such as aircraft 102, as well as flights flown by a particular pilot flying the same aircraft or multiple aircraft.

The pages 600-630 show how the categorized flight data may be mineable by a user for post flight analysis. Example page 600, depicted in FIG. 6A, includes phase model predictions for a CTOL mission alongside key aircraft telemetry signals. Example page 610, depicted in FIG. 6B, includes phase model predictions for a CTOL mission alongside key aircraft telemetry signals with the flight event aggregation overlaid. Example page 620, depicted in FIG. 6C, includes phase model predictions for VTOL testing alongside key aircraft telemetry signals. Example page 630, depicted in FIG. 6D, includes time tracking capabilities that use model classifications.

### Example Process

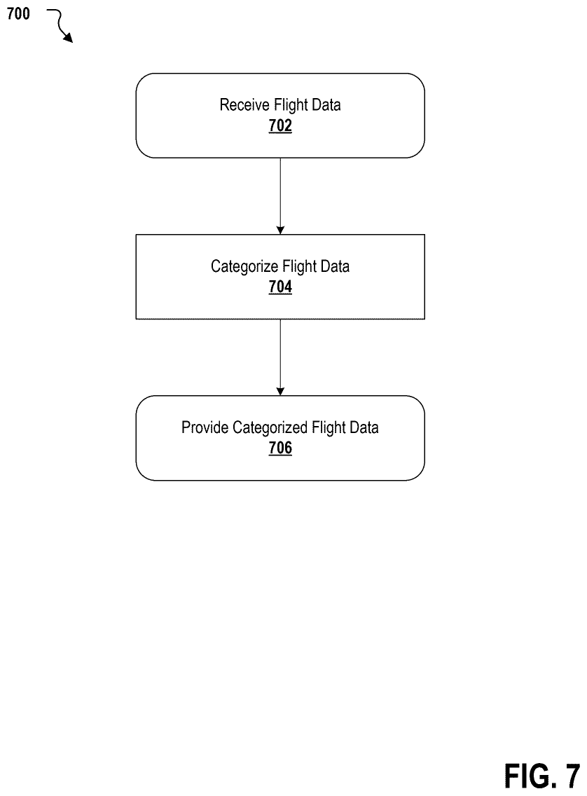

FIG. 7 depicts a flowchart of an example process 700 that can be implemented by implementations of the present disclosure. The example process 700 can be implemented by systems and components described with reference to FIGS. 1-6D and 8. The example process 700 generally shows in more detail how intervals of flight data are categorized with phases of flight.

For clarity of presentation, the description that follows generally describes the example process 700 in the context of FIGS. 1, 2, 4, 5, and 8. However, it will be understood that the process 700 may be performed, for example, by any other suitable system, environment, software, and hardware, or a combination of systems, environments, software, and hardware as appropriate. In some implementations, various operations of the process 700 can be run in parallel, in combination, in loops, or in any order.

At 702, flight data is received. In some implementations, the flight data is divided according to a plurality of time intervals and associated with a mission flown by an aircraft. In some implementations, a length of each of the plurality of time intervals is set according to an interval value. In some implementations, the interval value is determined based on the aircraft or information related to the mission.

In some implementations, the aircraft is an electrically powered VTOL aircraft or an electrically powered CTOL aircraft. In some implementations, the aircraft is capable of both a thrust-borne mode and a wing-borne flight mode. In some implementations, the wing-borne flight mode includes lift-plus-cruise or tiltrotor.

From 702, the process 700 proceeds to 704 where categorized flight data is determined by categorizing each of the plurality of time intervals of the flight data into at least one of a plurality of phases of flight. In some implementations, the plurality of time intervals of the flight data are categorized into the at least one of the plurality of phases of flight by processing the flight data through a statistical model. In some implementations, the statistical model is trained to categorize the flight data according to summary statistical values of the plurality of time intervals of the flight data to thereby capture temporal characteristics of the flight data. In some implementations, the at least one phase of flight includes one or more of phases of flight associated with a CTOL mission profile and phases of flight common to both the VTOL mission profile and the CTOL mission profile. In some implementations, the plurality of phases of flight include standing, taxi, takeoff, climb, cruise, descent, landing, hover, transition, and charging.

In some implementations, the plurality of time intervals of the flight data are categorized into the at least one of the plurality of phases of flight associated with the aircraft by processing the flight data through a statistical model and a rule-based classification logic component. In some implementations, the rule-based classification logic component is configured to identify phases of flight associated with a VTOL mission profile. In some implementations, the statistical model is trained to identify at least one phase of flight. In some implementations, the statistical model is trained to prefer takeoff and landing when classifying the flight data.

In some implementations, the statistical model is trained to categorize each of the plurality of time intervals of the flight data based on a rolling window employed to capture temporal features of the plurality of time intervals of the flight data. In some implementations, a size of the rolling window is determined based on a type of the aircraft or model employed. In some implementations, the flight data includes a plurality of signals, and wherein the statistical model is trained to categorize each of the plurality of time intervals of the flight data based on statistical metrics of each of the plurality of signals within the rolling window. In some implementations, a number of the temporal features is determined by calculating the statistical metrics of each of the plurality of signals over varying sizes of the rolling window. In some implementations, the statistical metrics include an aggregation, an average, a maximum value, or a minimum value. In some implementations, the plurality of signals includes airspeed, ground speed, altitude, heading, pusher throttle input, hover throttle input, weight on wheels indicator, or charging indicator.

In some implementations, the categorized flight data is processed to remove anomalies. In some implementations, the statistical model is trained to remove false positives by preferring takeoff and landing when classifying the flight data and detecting anomalies. In some implementations, the anomalies include a number of the plurality of time intervals categorized as one of the plurality of phases of flight that is shorter than a threshold duration. In some implementations, the anomalies include a transition between phases that violates a matrix of allowable phase transitions. In some implementations, the matrix of allowable phase transitions includes a plurality of transition rules defining, for each of the plurality of phases of flight, and allowable next phases of the plurality of phases of flight. In some implementations, the plurality of phases of flight and the matrix of allowable phase transitions are determined based on a type of the mission.

From 704, the process 700 proceeds to 706 where the categorized flight data is provided to a user interface for post flight analysis of the mission. In some implementations, the categorized flight data is associated with metadata related to the mission or the aircraft. In some implementations, the post flight analysis of the mission includes determining a maintenance task associated with the aircraft or a component of the aircraft. From 706, the process 700 ends or repeats.

### Example System

FIG. 8 depicts an example computing system 800 that includes a computer or computing device 810 that can be programmed or otherwise configured to implement systems or methods of the present disclosure. For example, the computing device 810 can be programmed or otherwise configured to implement the process 700. In some cases, the computing device 810 includes an operating system configured to perform executable instructions. The operating system is, for example, software, including programs and data that manages the device's hardware and provides services for execution of applications.

In the depicted implementation, the computer or computing device 810 includes an electronic processor (also “processor” and “computer processor” herein) 812, such as a central processing unit (CPU) or a graphics processing unit (GPU), which is optionally a single core, a multi core processor, or a plurality of processors for parallel processing. The depicted implementation also includes memory 817 (e.g., random-access memory, read-only memory, flash memory), electronic storage unit 814 (e.g., hard disk or flash), communication interface module 815 (e.g., a network adapter or modem) for communicating with one or more other systems, and peripheral devices 816, such as cache, other memory, data storage, microphones, speakers, and the like. In some implementations, the memory 817, storage unit 814, communication interface module 815 and peripheral devices 816 are in communication with the electronic processor 812 through a communication bus (shown as solid lines), such as a motherboard. In some implementations, the bus of the computing device 810 includes multiple buses. The above-described hardware components of the computing device 810 can be used to facilitate, for example, an operating system and operations of one or more applications executed via the operating system. For example, flight data categorized with phases of flight according to implementation described here may be provided via the user interface 825. In some implementations, the computing device 810 includes more or fewer components than those illustrated in FIG. 8 and performs functions other than those described herein.

In some implementations, the memory 817 and storage unit 814 include one or more physical apparatuses used to store data or programs on a temporary or permanent basis. In some implementations, the memory 817 is volatile memory and can use power to maintain stored information. In some implementations, the storage unit 814 is non-volatile memory and retains stored information when the computer is not powered. In further implementations, memory 817 or storage unit 814 is a combination of devices such as those disclosed herein. In some implementations, memory 817 or storage unit 814 is distributed across multiple machines such as a network-based memory or memory in multiple machines performing the operations of the computing device 810.

In some cases, the storage unit 814 is a data storage unit or data store for storing data. In some instances, the storage unit 814 stores files, such as drivers, libraries, and saved programs. In some implementations, the storage unit 814 stores data received by the device (e.g., a generative model for a vector process). In some implementations, the computing device 810 includes one or more additional data storage units that are external, such as located on a remote server that is in communication through a network (e.g., the communications network 510 described above with reference to FIG. 5).

In some implementations, platforms, systems, media, and methods as described herein are implemented by way of machine or computer executable code stored on an electronic storage location (e.g., non-transitory computer readable storage media) of the computing device 810, such as, for example, on the memory 817 or the storage unit 814. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 812 is configured to execute the code. In some implementations, the machine executable or machine-readable code is provided in the form of software. In some examples, during use, the code is executed by the electronic processor 812. In some cases, the code is retrieved from the storage unit 814 and stored on the memory 817 for ready access by the electronic processor 812. In some situations, the storage unit 814 is precluded, and machine-executable instructions are stored on the memory 817.

In some cases, the electronic processor 812 is a component of a circuit, such as an integrated circuit. One or more other components of the computing device 810 can be optionally included in the circuit. In some cases, the circuit is an application specific integrated circuit (ASIC) or a field programmable gate arrays (FPGAs). In some cases, the operations of the electronic processor 812 can be distributed across multiple machines (where individual machines can have one or more processors) that can be coupled directly or across a network.

In some cases, the computing device 810 is optionally operatively coupled to a communications network, such as the communications network 510 described above with reference to FIG. 5, via the communication interface module 815, which may include digital signal processing circuitry. Communication interface module 815 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver.

In some cases, the computing device 810 includes or is in communication with one or more output devices 820. In some cases, the output device 820 includes a display to send visual information to a user. In some cases, the output device 820 is a touch sensitive display that combines a display with a touch sensitive element that is operable to sense touch inputs as and functions as both the output device 820 and the input device 830. In still further cases, the output device 820 is a combination of devices such as those disclosed herein. In some cases, the output device 820 displays a user interface 825 generated by the computing device.

In some cases, the computing device 810 includes or is in communication with one or more input devices 830 that are configured to receive information from a user. In some cases, the input device 830 is a keyboard. In some cases, the input device 830 is a keypad (e.g., a telephone-based keypad). In some cases, the input device 830 is a cursor-control device including, by way of non-limiting examples, a mouse, trackball, trackpad, joystick, game controller, or stylus. In some cases, as described above, the input device 830 is a touchscreen or a multi-touchscreen. In other cases, the input device 830 is a microphone to capture voice or other sound input. In other cases, the input device 830 is an imaging device such as a camera. In still further cases, the input device is a combination of devices such as those disclosed herein.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 812. As such, it should be noted that a plurality of hardware and software-based devices, as well as a plurality of different structural components may be employed to implement various implementations.

In some implementations, a system includes a user interface and an aircraft. The aircraft includes a plurality of sensors and an on-board computing system communicably coupled to the plurality of sensors. The on-board computing system is configured to capture, via the plurality of sensors, flight data comprising a plurality of signals and divided into a plurality of time intervals. The system includes an electronic processor communicably coupled to the on-board computing system and the user interface. The electronic processor is configured to: receive the flight data from the on-board computing system, generate a plurality of respective features for the plurality of time intervals based on statistical metrics of each of the plurality of signals, determine categorized flight data by categorizing each of the plurality of time intervals into at least one of a plurality of phases of flight based on a plurality of temporal features, and provide the categorized flight data to the user interface for post flight analysis of a mission.

In some implementations, a computer-readable medium storing instructions that when executed by an electronic processor cause the electronic processor to execute operations. These operations include: receiving flight data divided according to a plurality of time intervals and associated with a mission flown by an aircraft; determining categorized flight data by categorizing each of the plurality of time intervals of the flight data into at least one of a plurality of phases of flight by processing the flight data through a statistical model and a rule-based classification logic component, wherein the rule-based classification logic component is configured to identify phases of flight associated with a vertical takeoff or landing (VTOL) mission profile, and wherein the statistical model comprises a statistical model trained to identify phases of flight associated with a conventional takeoff or landing (CTOL) mission profile and phases of flight common to both the VTOL mission profile and the CTOL mission profile; and providing the categorized flight data to a user interface for post flight analysis of the mission.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, an aircraft is a vehicle that is capable of flight. As a non-limiting example, aircraft may include airplanes, helicopters, airships, blimps, gliders, paramotors, and the like thereof. Aircraft may include electrical aircraft as well as fuel powered aircraft.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving flight data divided according to a plurality of time intervals and associated with a mission flown by an aircraft;
determining categorized flight data by categorizing each of the plurality of time intervals of the flight data into at least one of a plurality of phases of flight; and
providing the categorized flight data to a user interface for post flight analysis of the mission.

2. The method of claim 1, wherein the plurality of time intervals of the flight data are categorized into the at least one of the plurality of phases of flight by processing the flight data through a statistical model, and
wherein the statistical model is trained to categorize the flight data according to summary statistical values of the plurality of time intervals of the flight data to thereby capture temporal characteristics of the flight data.

3. The method of claim 2, wherein the at least one phase of flight includes one or more of phases of flight associated with a conventional takeoff or landing (CTOL) mission profile and phases of flight common to both a vertical takeoff or landing (VTOL) mission profile and the CTOL mission profile.

4. The method of claim 3, wherein the plurality of phases of flight include at least one of standing, taxi, takeoff, climb, cruise, descent, landing, hover, transition, or charging.

5. The method of claim 1, wherein the plurality of time intervals of the flight data are categorized into the at least one of the plurality of phases of flight associated with the aircraft by processing the flight data through a statistical model and a rule-based classification logic component.

6. The method of claim 5, wherein the rule-based classification logic component is configured to identify phases of flight associated with a vertical takeoff or landing (VTOL) mission profile.

7. The method of claim 6, wherein the statistical model is trained to identify at least one phase of flight.

8. The method of claim 5, wherein the statistical model is trained to prefer takeoff and landing when classifying the flight data.

9. The method of claim 5, wherein the statistical model is trained to categorize each of the plurality of time intervals of the flight data based on a rolling window employed to capture temporal features of the plurality of time intervals of the flight data,
wherein the flight data includes a plurality of signals, and
wherein the statistical model is trained to categorize each of the plurality of time intervals of the flight data based on statistical metrics of each of the plurality of signals within the rolling window.

10. The method of claim 9, wherein a size of the rolling window is determined based on a type of the aircraft or model employed,
wherein a length of each of the plurality of time intervals is set according to an interval value, and
wherein the interval value is determined based on the aircraft or information related to the mission.

11. The method of claim 9, where a number of the temporal features is determined by calculating the statistical metrics of each of the plurality of signals over varying sizes of the rolling window.

12. The method of claim 9, wherein the statistical metrics include at least one of an aggregation, an average, a maximum value, or a minimum value.

13. The method of claim 9, wherein the plurality of signals includes at least one of airspeed, ground speed, altitude, heading, pusher throttle input, hover throttle input, weight on wheels indicator, or charging indicator.

14. The method of claim 1, further comprising:
processing the categorized flight data to remove anomalies.

15. The method of claim 14, wherein the anomalies include a number of the plurality of time intervals categorized as one of the plurality of phases of flight that is shorter than a threshold duration.

16. The method of claim 14, wherein the anomalies include a transition between phases that violates a matrix of allowable phase transitions.

17. The method of claim 16, wherein the matrix of allowable phase transitions includes a plurality of transition rules defining, for each of the plurality of phases of flight, and allowable next phases of the plurality of phases of flight.

18. The method of claim 16, wherein the plurality of phases of flight and the matrix of allowable phase transitions are determined based on a type of the mission.

19. A system comprising:
a user interface;
an aircraft including:
a plurality of sensors, and
an on-board computing system communicably coupled to the plurality of sensors and configured to capture, via the plurality of sensors, flight data comprising a plurality of signals and divided into a plurality of time intervals; and
an electronic processor communicably coupled to the on-board computing system and the user interface, the electronic processor configured to:
receive the flight data from the on-board computing system,
generate a plurality of respective features for the plurality of time intervals based on statistical metrics of each of the plurality of signals,
determine categorized flight data by categorizing each of the plurality of time intervals into at least one of a plurality of phases of flight based on a plurality of temporal features, and
provide the categorized flight data to the user interface for post flight analysis of a mission.

20. A computer-readable medium storing instructions that when executed by an electronic processor cause the electronic processor to execute operations, the operations comprising:
receiving flight data divided according to a plurality of time intervals and associated with a mission flown by an aircraft;
determining categorized flight data by categorizing each of the plurality of time intervals of the flight data into at least one of a plurality of phases of flight processing the flight data through a statistical model, wherein the statistical model is trained to categorize the flight data according to summary statistical values of the plurality of time intervals of the flight data to thereby capture temporal characteristics of the flight data; and
providing the categorized flight data to a user interface for post flight analysis of the mission.
